(19) United States
(12) Patent Application Publication
(10) Pub. No.: US 2015/0279132 A1
(43) Pub. Date: Oct. 1, 2015

(54) Integration of Physical Access Control

(71) Applicant: Plantronics, Inc., Santa Cruz, CA (US)

(72) Inventor: Erik Perotti, Santa Cruz, CA (US)

(73) Assignee: Plantronics, Inc., Santa Cruz, CA (US)

(21) Appl. No.: 14/226,714

(22) Filed: Mar. 26, 2014

(51) Int. Cl. G07C 9/00

(52) U.S. Cl. CPC G07C 9/00103; G07C 9/00087; G07C 9/00039

(57) ABSTRACT

A security identification system is described that receives and processes multiple security credentials that have been configured by different network authenticators, devices configured to provide security credentials to user access devices, such as mobile phones and bracelets. The security identification system having multiple security certificates allows an employee to enter different locked physical facilities maintained by an employer when each of the locked physical facilities has been secured by a different security protocol, including security protocols provided by different security vendors. The security identification system may obtain security credentials over a network cloud service. The security identification system may take a variety of wearable forms, such as a bracelet, eyeglasses, rings, or ear buds, as well as forms such as a mobile phone. The security identification system may include a biometric reading device that measures users to verify that the person controlling an access device is its authorized user.

### FIELD

Embodiments of the invention relate to systems and methods for wearable technologies, physical access, cloud-based technologies, and contextual intelligence. More particularly, an embodiment of the invention relates to systems and methods that facilitate the identification and admission process for closed and/or secure facilities.

### BACKGROUND

Opening a secured door has historically been tied to user-worn keycards and key-fobs. For at least 30 years, employees and visitors have received from the employer's facilities manager a keycard or key-fob that provides access to the employer's secure and/or closed facility. The keycards are typically provided on the employees' first day of work. The connection between a specific facility and its security means that one might need a card to enter an office in one location, and a second card to enter an office in a second location. Thus, keycards and similar technologies have conventionally provided an acceptable entry/access control solution only for individual facilities or for just a portion of a facility. For example, an employee's keycard might not work in the data center of his office but will provide access in other areas.

Many companies, especially multinational ones, maintain physical offices across a variety of locations in a variety of countries and geographies. A local or regional facilities department has often designed and implemented a physical building access plan and related systems that are different or otherwise inconsistent with the other security systems in place throughout the other parts of the corporation. For some companies, each physical location's building access has been designed and implemented by a different regional facilities department. The complete range of corporate security solutions might not even be available in all locations. In many cases, the overall corporate physical access plan has not been designed with a consistent, universal objective in mind.

Many companies, even ones that do not operate globally, often maintain facilities having different physical building access plans that are not consistent or universal throughout the company. A company might use one security provider at a first physical location and use a second security provider at a second physical location.

For example, the electronics company Plantronics has conventionally employed one security service provider for its Santa Cruz, Calif. offices and another provider for its Swindon, Wiltshire, UK offices. HID Global provides the Security Identification Systems for Plantronics' Santa Cruz office. HID Global is presently owned by Assa Abloy, a Swedish multinational security supplier and manufacturer of locks, which despite its European footprint is not the provider for the company's Swindon office. Security at the company's Swindon office is provided by HID i-class cards and readers connected to a Paxton Net2 system.

At Plantronics' office in Santa Cruz, on an employee's first day of work, the employee is issued a generic physical access card. Plantronics' facilities manager together with an associate then couples that badge in a server associated with a computerized Source of Truth system having very tight security. There are exactly two employees at Plantronics who have access to this computerized system, which is conventionally known as a Source of Truth system. The function of a computerized Source of Truth system is to provide information about who specifically has access to the company's facilities. The Source of Truth system maintains the data related to access, such as “Erik Perotti, Employee 4332198, has access to Doors 45, 53-62, and 101 at the Santa Cruz facility.”

This computerized Source of Truth system is coupled to the HID Global system mentioned above, which controls the actual physical access readers at the company's facilities. Put another way, once an employee has an active badge, the employee can gain entry into at least some doors at the Plantronics' Santa Cruz office. If the employee wants access to some more advanced doors or privileges, like access after 5:00 p.m., the company has a control that is managed through the system run by Plantronics' facilities team.

The HID pros came into our site to figure out how this would work. They did the same exploration, architectural discovery in Swindon independent of what we did here. Different processes, and so forth.

Even though a given employee's access card contains the correct entry code information for entering all Plantronics' facilities, an employee from the Santa Cruz office cannot arrive at the Swindon office and expect that his access card will open the secure door. Among other things, the physical card used in Santa Cruz while having the correct entry code cannot convey this information to the Swindon facility because at the physical access level, the security systems do not communicate with each other. Specifically, a card encoded to be read by a HID Global device cannot be read by a HID i-class reading device.

In some circumstances, the same card may be read by access systems from different vendors. For example, some systems coded in base 10 are interchangeable with systems coded in base 8. However, without knowing a priori that two systems are compatible, one cannot assume that the physical access system at one location is compatible with the physical access system at another location.

FIG. 1 illustrates a conventional Security Identification System 100 that can be found in the prior art. A Network Authenticator 102 provides appropriate security credentials 112 to a user-worn keycard 104. Once the appropriate security credentials 112 have been added to the keycard 104, then the keycard 104 can be used to open secure doors at a First Facility 108.

In the conventional Security Identification System 100, the keycard 104 provides authentication information associated with the keycard 104. A security access control certificate 114 engages the opening of the locks in the First Facility 108 operated by physically moving detainers in a locking mechanism activated by the presence and/or insertion of the keycard 104 at the First Facility 108. The sensor 109 has previously been provided with the codes that match the security access control certificate 114, or the equivalent, and the sensor 109 can perform a comparison to see if these credentials match.

Conventional keycard systems comprising a Network Authenticator 102, a keycard 104, and a sensor 109, include technologies such as shining LEDs through a pattern of holes in the keycard 104 and detecting the result, or by swiping or inserting a magnetic stripe keycard 104, or in the case of Radio Frequency Identification (“RFID”) keycards 104, merely bringing the keycard 104 into close proximity to a sensor 109 associated with the First Facility 104. Keycards 104 may also serve as ID cards. Some electronic access control locks use a Wiegand interface to connect the card swipe mechanism to the rest of the electronic entry system. Many contemporary keycard systems employ RFID. These keycards are typically more secure, and also are not subject to being corrupted as easily as a magnetic card.

The Network Authenticator 102 configures the conventional keycard 104 using a technology appropriate to the keycard type, such as mechanical holecards, bar codes, magnetic stripes, Wiegand wire embedded cards, smart cards (e.g., keycards embedded with a read/write electronic microchip), and RFID proximity cards. So, for example, the Network Authenticator 102 for the keycard 104 of the magnetic strip type would magnetize the keycard 104 with the security access control certificate 114 such that the sensor 109 would be able to read the keycard 104 when presented by the cardholder. Different technologies would encode the cardholder credentials differently. The security access control certificate 114 might possibly be identical in coding (e.g., “1010 1110 1101 1001 1010 1110 1101 1001”) from technology to technology albeit outwardly expressed in a different manner or the encoded security access control certificate 114 could be completely different from technology to technology.

The Network Authenticator 102 typically comprises a hardware device that is capable of encoding the keycard 104 with a set of codes that can authenticate the cardholder and thus open secure doors at the First Facility 108.

The Network Authenticator 102 is likely associated with the security system at a particular physical location. For example, in the Plantronics example above, the Network Authenticator 102 might be associated with the company's Santa Cruz location but not associated with the company's Swindon location. Accordingly, when the employee associated with the keycard 104 attempts to enter or otherwise access the First Facility 108, the keycard 104 provides the security access control certificate 114 that will trigger the opening of the appropriate entry point (e.g., a door) associated with the security access control certificate 114 or otherwise provide access to the First Facility 108. In the Plantronics example, the First Facility 108 could be the company's office in Santa Cruz.

On the other hand, if the employee associated with the keycard 104 travels to a Second Facility 110, then the keycard 104 will be unable to generate the appropriate security access control certificate 116 that would provide access to the Second Facility 110. Using the Plantronics example above, one could assume here that the Second Facility 110 corresponds to the Plantronics Swindon office in the UK.

Thus, because the Network Authenticator 102 is not configured to provide the security access control certificate 116 for the Second Facility 110, then the employee associated with the keycard 104 will need to obtain a second badge to enter the Second Facility 110.

Of course, a company could organize its Security Identification System 100 such that only a single keycard was necessary for every facility, but for the reasons discussed above this is unlikely to happen frequently in practice.

In many conventional settings, it is unlikely that the Network Authenticator 102 can be expanded to provide the security access control certificate 116 for the Second Facility 110 since the security access control certificates 114, 116 are often proprietary and associated with a specific network authenticator provided by a company other than the one that provided the Network Authenticator 102. Thus, in this example, the security access control certificate 116 is associated with a network authenticator that generates a different set of security access control certificates than the Network Authenticator 102.

As shown in FIG. 1, if an employee travels to a new location within the same company, the employee's keycard may not work at the new facility. Thus, an employee of Plantronics would need to obtain one keycard to enter the company's Santa Cruz, California office and second card to enter the company's Swindon, UK office. This could become expensive for the company, especially in terms of lost productivity.

In this prior art example, the keycard 104 could be replaced with a key fob and the results would be identical. Facility access systems tend to be proprietary and as pointed out above, they are often associated with a particular physical location.

Coupled with the productivity and convenience issues associated with the problem of proper security credentialing, unified communications also represents an important aspect of productivity in contemporary business culture, and its success from company to company can serve as a bellwether indication of the company's overall management success. An essential feature behind unified communications is the ability to have a single way for reaching an employee. Thus, in a fully configured unified communications environment, all messages to an employee, regardless of the format of their origin (e.g., e-mail) will reach the employee at the earliest possible moment via another format (e.g., SMS) if necessary. Unified communications systems typically comprise not a single system but the integration of data from a potentially unlimited set of separate communications devices and systems.

Presence information relates to unified communication and refers to the combination of the availability of a communication recipient to receive a message and that person's willingness to speak. For example, if the message sender is online according to the presence information and currently accepts calls, the response can be sent immediately through text chat or video call. Otherwise, the communication may be sent as a non real-time message that can be accessed through a variety of media. Thus, presence information typically represents a status indicator that conveys the availability and willingness of a potential communication partner.

Security identification systems 100 can play an important role in determining a user's presence. The Security identification system 100 can log which employees are physically present in corporate sites. In the Plantronics example above, the Security identification system 100 can provide information to a presence system indicating whether an employee is physically present in either the Santa Cruz or Swindon facilities. Of course, an employee might not be willing or able to communicate at any given moment, but nevertheless knowing that an employee is present can be helpful. The employee's presence could be gathered by linking the employee security system to the presence system, and possibly linking the two systems even closer together using other security devices such as video monitors.

In addition to the problems identified thus far, an analogous problem exists with home security. Homeowners, apartment dwellers, and even hotel guests tend to use either physical keys or at best keycards. Home security systems tend conventionally to be binary—one either has total access by virtue of possession of a physical key or no access at all due to the absence of a key. Access can typically be controlled only by dispensing multiple physical keys, although specialized keys are possible, especially for incidental users such as plumbers, dog walkers, and groups of Facebook friends.

Attempts to solve these problems in the prior art have tended to be either overly complicated, overly expensive, or both. To further complicate matters, many corporations outsource huge portions of their security identification systems to third party vendors. For a sufficiently large multinational corporation with many physical plants, this conventionally means that either a single vendor needs to be selected or the company must undertake the arduous task of convincing some number of competitive security companies to actually work together to integrate their systems. A simple and robust solution is called for that makes security identification systems more compatible and also renders unified communications more robust and ubiquitous and further unites the elements of the user's communication system and its related equipment.

### SUMMARY OF THE INVENTION

Embodiments of the invention provide a security identification system that operates in conjunction with a plurality of network authenticators. In the security identification system, a computerized certificate application receives a plurality of security credentials from the plurality of network authenticators, wherein each security credential comprises an access code to a locked physical facility, and wherein each security credential has been differently coded in comparison to at least one other security credential received by the computerized certificate application, wherein the computerized certificate application processes different types of security credentials prepared by different types of network authenticators and prepares security access certificates from the security credentials. The security identification system also includes a transceiver package configured to receive security credentials from a plurality of network authenticators and further configured to transmit security access control certificates to at least one sensor associated with a locked physical facility wherein transmitted security access control certificates engage unlocking the locked physical facility for a user associated with the computerized certificate application. The security identification system includes a data repository configured to store security access control certificates prepared by the computerized certificate application.

Embodiments of the invention also enable a method for providing a security identification system that operates in conjunction with a plurality of network authenticators. The method includes receiving a plurality of security credentials on a computerized certificate application from a plurality of network authenticators, wherein each security credential comprises an access code to a locked physical facility, and wherein each security credential has been uniquely coded in comparison to at least one other security credential received by the computerized certificate application, and wherein the computerized certificate application processes different types of security credentials prepared by different types of network authenticators and prepares security access certificates from the security credentials. The method further includes receiving a plurality of security credentials from a plurality of network authenticators by a transceiver package and transmitting security access control certificates to at least one sensor associated with a locked physical facility wherein transmitted security access control certificates engages unlocking to the locked physical facility for a user associated with the computerized certificate application. The method also includes storing security access control certificates prepared by the computerized certificate application in a data repository.

### BRIEF DESCRIPTION OF THE DRAWINGS

FIG. 1 illustrates a conventional Security Identification System 100 that can be found in the prior art;

FIG. 2 illustrates an improved Security Identification System 200 operating on a mobile phone, according to an embodiment of the invention;

FIG. 3 illustrates a Security Identification System 300 that uses a cloud service to provide enhanced security over the Security Identification System 100 shown in FIG. 1, according to an embodiment of the invention;

FIG. 4 illustrates various components of a wearable access device 400, such as the bracelet 308 shown in FIG. 3, according to an embodiment of the invention;

FIGS. 5A-5B provide a flowchart 500 that illustrates operations of a security identification system for a wearable access device, such as the security identification system 300 shown in FIG. 3, according to an embodiment of the invention;

FIG. 6 illustrates a security identification system 600 in which the wearable access device comprises a pair of eyeglasses 601, according to an embodiment of the invention;

FIG. 7 illustrates a security identification system 700 where the wearable access device comprises an audio device, such as an ear bud 701, according to an embodiment of the invention;

FIG. 8 illustrates a security identification system 800 where the wearable access device comprises a ring 808, according to an embodiment of the invention; and

FIG. 9 illustrates a residential security identification system 900 that operates along similar principles to the Security Identification System 300 shown in FIG. 3, according to an embodiment of the invention.

### DETAILED DESCRIPTION OF AN EMBODIMENT OF THE INVENTION

Embodiments of the invention simplify universal security control access for facility operators and streamline users' needs for multiple access devices (e.g., keycards) when secure access to multiple physical sites involves multiple security vendors and/or multiple security systems. Embodiments of the invention may employ wearable technologies, cloud-based technologies, and/or contextual intelligence to provide an enhanced security identification system. Embodiments of the invention may provide both enhanced security for the owners and operators of secure facilities while also streamlining the procedure for universal access.

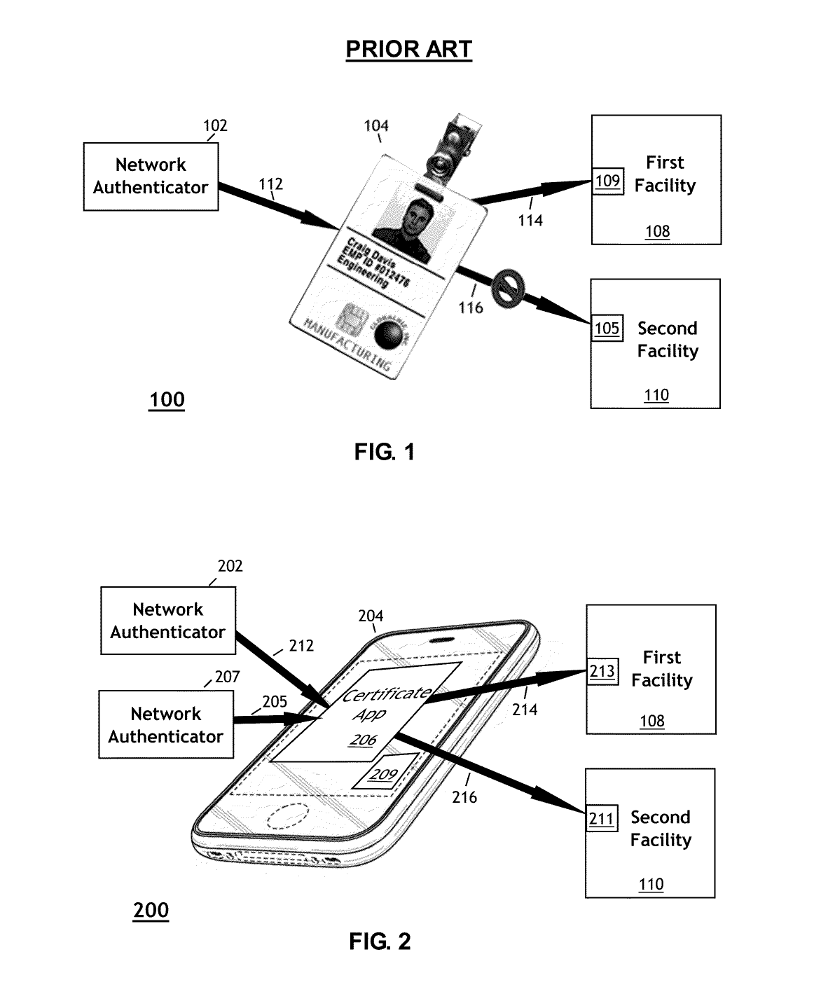

Access devices such as keycards and key-fobs are conventionally linked to a single security services provider. Changing the one-to-one association between access devices and security service providers may offer an improvement over the conventional keycard approach shown in FIG. 1.

Existing devices, such as mobile phones, could be modified to serve as access devices having functionality and security features resembling keycards. The combination of mobile phones and smartphone applications can be adapted for security access purposes to provide keycard-like access functionality. Depending on the security vendor and the specific mobile phone configuration, users may need to obtain separate credentials and/or security applications for each facility they visit.

More importantly, smartphone-enabled access devices can be enhanced beyond conventional keycards to operate with applications and/or security credentials from multiple security vendors. In addition, smartphone applications can support higher levels of encryption than many conventional keycard technologies. The use of smartphone applications may provide simpler authentication than conventional keycards, making access easier for users because, among other things, they will not have to remember to bring another object to work. In addition, embodiments of the invention allow may allow a security provider, such as a person's employer, to provision a person's personal device (e.g., a smartphone), with a key that operates like a small piece of an integrated work/personal device.

Embodiments of the invention may provide greater flexibility for facility security managers. Among other things, barriers to switching between security vendors due to proprietary physical access equipment and related control mechanisms may be removed by embodiments of this invention. Additionally, the invention may be helpful for facility sizing purposes. Assume, for example, that at Plantronics' Santa Cruz facility, the company opts to have “Plan A” from HID because that's all the company can afford at the moment, but at some future date, the company plans to move to “Plan B” having better, worse or otherwise different security controls. Additional facilities flexibility provided by the invention may include temporary arrangements with specific employees. Assume that on Day X, every employee gets access to the executive gym, but only on that day—or assume that a building supervisor has a high turnover property and decides to use security certificates that expire more frequently than would normally be the situation.

FIG. 2 illustrates an improved Security Identification System 200, according to an embodiment of the invention. The Security Identification System 200 enables wearable access devices and wireless communication devices to function in a manner similar to the keycard 104 shown in FIG. 1.

The Network Authenticator 202 provides a security credential 212 to a certificate app 206 on a mobile phone 204. The security credential 212 includes codes for opening a specific cite, e.g., the First Facility 108 by virtue of the sensor 213. The certificate app 206 receives the security credential 212 and transforms the security credential 212 into a security access control certificate and stores the certificate securely in a data repository 209 on the mobile phone 204, according to an embodiment of the invention.

Security access control certificates, such as those produced from the security credential 212, may be configured to expire after a certain date or event, according to an embodiment of the invention. Among other things, a periodic expiration of the certificates could be used as a mechanism for forcing various system updates as part of a security renewal process, according to an embodiment of the invention

Once the security credential 212 has been received and processed by the mobile phone 204, then if the holder of the mobile phone 204 approaches the First Facility 108, the certificate app 206 will provide the appropriate security access control certificate 214 to the sensor 213 that then motivates opening the appropriate access doors for the person holding the mobile phone 204, according to an embodiment of the invention. The ordinary artisan will appreciate that the example provided here describes a mobile phone having applications; the example here would apply equally to other types of portable and/or wearable access devices having computer processing capabilities. The mobile phone 204 includes a computing device capable of receiving new applications.

In some embodiments, the sensors 211, 213 may require modifications in order for the invention to operate properly. For example, if the security access control certificate 214 is being provided wirelessly, then the sensors 211, 213 need to be capable of receiving credentials wirelessly. In addition, if the sensor 211, 213 have different proprietary formats, then these proprietary formats needs to be modified and/or the certificate app 206 needs to understand enough about each of the proprietary formats to create a security access control certificate 214 for each of the proprietary formats requested by the sensors 211, 213.

Referring back to the Plantronics example of FIG. 1, the First Facility 108 could be the company's Santa Cruz plant. So all an employee would need to do to enter the company's facility is present the mobile phone 204 to the sensor 213. The organic transceiver on the mobile phone 204 provides the communications with the Network Authenticator 202, 207 and the sensors 211, 213.

The security identification system 200 provided by the combination of the Network Authenticator 202, the Certificate app 206, the security access control certificate 214, and the sensor 213 could comprise many types of conventional security devices. For example, the system could operate as an RFID system. The combination above could even accommodate hardware for security systems in development. The mobile phone 204 is especially adaptable for such a security identification system since the mobile phone 204 already includes a transceiver and related functionality for sending audio and text communications.

In the Security Identification System 200, if the holder of the mobile phone 204 approaches the Second Facility 110, the certificate app 206 will also send the security access control certificate 216 to a sensor 211 associated with the second facility 110. Thus, the security access control certificate 216 will motivate the opening of the second facility 110 to the holder of the mobile phone 204. As mentioned above, in some instances, the certificate app 206 may need to code the security access control certificate 216 in a format (e.g., a proprietary format) that can be read by the sensor 211.

The security identification system 200 provided by the combination of the network authenticator 207, the certificate app 206, the security credential 205, and the sensor 211 could be fundamentally the same as the security system provided by the combination of the network authenticator 202, the certificate app 206, and the sensor 213—or it could be a completely different system that utilizes a different technology.

Of course, the certificate app 206 may accommodate a variety of security systems and protocols, according to an embodiment of the invention. The only thing that needs to be similar between the Security Identification System 200 and a conventional security system, such as that shown in FIG. 1, is the handling and presentation of security access control certificates and related devices by the access control device.

In an alternative embodiment of the invention, the certificate app 206 comprises essentially two separate security applications, one application that supports the network authenticator 202, the security credential 212, and the sensor 213 and another application that supports the network authenticator 207, the credentials 205, and the sensor 211. This particular embodiment of the invention could be particularly amenable to situations in which a security firm associated with the network authenticator 202 and the sensor 213 wished to keep its approach to security (e.g., its security credential) completely proprietary without having to share details with a third party. Some security vendors might only provide the security credential 212 if the company still controlled proprietary access to it. The Security Identification System 200, or at least the portion having to do with obtaining proprietary security credentials, could be developed in partnership with a security company associated with the Network Authenticator 202, such as HID Global mentioned above in the Plantronics example.

Conventional mobile phones, such as the mobile phone 204, have been developed to accept new applications, such as the Certificate app 206. The Certificate app 206 can be uploaded and installed on the mobile phone 204 in the conventional network. Once the Certificate app 206 has been placed on the mobile phone 204, then the certificate app 206 could operate in a manner similar to any other application operating on the mobile phone 204, in a manner conventional to mobile telephony, and mobile computing devices. Of course, a conventional mobile phone includes a computing element such as a computer processing unit (“CPU”). In addition, the operation of such devices is well known in the art and also known to artisans of ordinary skill in the relevant field.

The Security Identification System 200 may alleviate the difficulties of providing access to facilities located in different places and/or facilities having different security systems. In short, a device (e.g., the mobile phone 204) that provides access in one location can be configured to also provide access in a second location, including even a second location that employs an alternative security system.

Access control over the security access device represents one problem that could arise with the Security Identification System 100 and to some extent with the Security Identification System 200. Any holder of the keycard 104 could gain access to the First Facility 108 and/or the Second Facility 110. For example, any holder of the mobile phone 204, apart from the mobile phone's organic security such as an access PIN code, could also gain access to the First Facility 108 and/or the Second Facility 110. Of course, the mobile phone 204 likely has a device password, but assuming the holder of the mobile phone 204 has obtained the legitimate holder's password, then facility access can be attained. A further solution would be desirable so as to thwart efforts to circumvent security by simply stealing the mobile phone 204 shown in FIG. 2.

In addition, the Security Identification System 200 shown in FIG. 2 may be further enhanced through embodiments of the invention in which a layer of cloud services is interposed between the network authenticator(s) and the user platform or user device that presents security access control certificates. The cloud services can function as an aggregator role for passing facilities definitions (e.g., security access control certificates). Such embodiments enable greater flexibility and autonomy to a security identification system. This flexibility may make access purchasing decisions for a given locking system based on the best solution for a specific place/time, and the facility manager need not be wedded to one vendor for universal physical access.

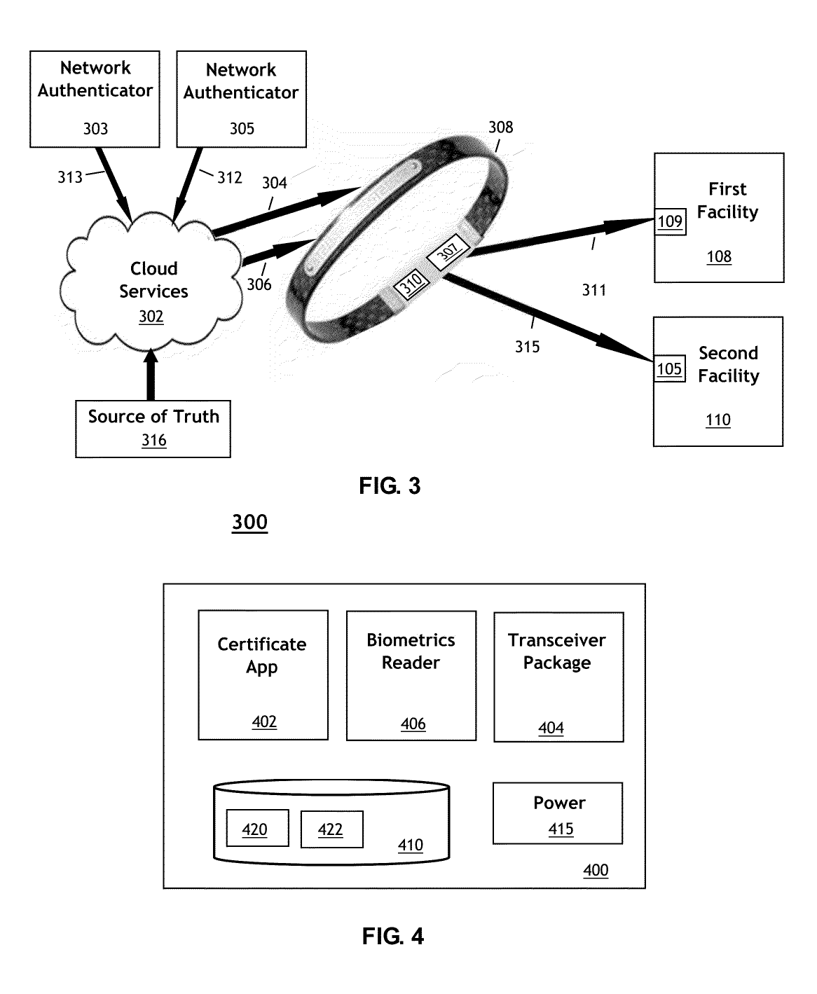

FIG. 3 illustrates a Security Identification System 300 that provides enhanced security over the Security Identification System 100 shown in FIG. 1, according to an embodiment of the invention. The Security Identification System 300 comprises Network Authenticators 303, 305, a security bracelet 308, and sensors 109, 105, respectively located in the First Facility 108 and the Second Facility 110, according to an embodiment of the invention. As discussed below, the transfer of security credentials from the Network Authenticators 303, 305 to the security bracelet 308 is facilitated by a variety of cloud services 302, according to an embodiment of the invention.

The cloud services 302 provide a streamlined and uniform approach for transmitting security credentials from network authenticators, such as the network authenticators 303, 305, which tend to be proprietary, and the bracelet 308. The cloud services 302 comprise a large number of computers connected through a real-time communication network such as the Internet. The cloud services 302 provide distributed computing over a network, and the computing power needed to run a program or application on many connected computers at the same time. The cloud services 302 provides network-based services, which may appear to the Network Authenticators 303, 305 and to the bracelet 308 to be provided by real server hardware, but may actually be served up by virtual hardware, simulated by software running on one or more real machines, according to an embodiment of the invention.

According to embodiments of the invention, the cloud services 302 may provide: user authentication, personnel specific information such as a user's retinal display and PIN number, the user's email address for communication, the user's AD username and password (if Active Directory is the security provider), what offices the user can access, the user's default office location, the user's last/most recent office location, a log of office ins and outs, other locations where the user accesses his product, and whether the user is at one of those places currently.

The cloud services 302 help maintain a uniform security policy for the Security Identification System 300 through its interactions with a computerized Source of Truth 316. As discussed earlier, the Source of Truth 316 is a fairly conventional device located within most security systems. A Source of Truth system, such as the Source of Truth 316, maintains a corporation's records for who within the organization has physical access to the system's facilities. Of course, who has access to a facility is a business-level decision. Thus, Source of Truth system 316 is essentially the system of record for a company's physical access data. In other words, the Source of Truth 316 is defined as always being right all the time about employee records.

The cloud services 302 help facilitate a uniform security policy for the Security Identification System 300 in conjunction with the computerized Source of Truth 316. The computerized Source of Truth 316 may comprise an approach similar to Active Directory (AD), according to various embodiments of the invention. AD is a directory service implemented by Microsoft for Windows domain networks that is included in most Windows Server operating systems. An AD domain controller authenticates and authorizes all users and computers in a Windows domain type network and assigns and enforces security policies for all computers and installing or updating software. For example, when a user logs into a computer that is part of a Windows domain, Active Directory checks the submitted password and determines whether the user is a system administrator or normal user. Active Directory makes use of the Lightweight Directory Access Protocol (LDAP) versions 2 and 3, Microsoft's version of Kerberos, and DNS. In some embodiments of the invention, some records may reside outside of Active Directory, so as to accommodate various temporary workers, such as contractors and various cleaning and delivery persons.

A number of other devices can provide the computerized Source of Truth 316. Oracle Corporation's Master Data Management (MDM), for example, provides a source of truth product that helps companies determine who is currently an associate, a temporary contractor, an intern, and so forth.

The cloud services 302 may help make a proprietary vendor feel more comfortable about allowing a third party device to have access credentials for the vendor's security system on the basis of mutual exclusivity. Meaning, if the employee's mobile device containing the security credentials is not near the office where the credentials are accessed, then the mobile device may be configured to not have (e.g., delete) the credentials, according to an embodiment of the invention. The security system 300 could even be configured to cross check the employee's mobile device, e.g., if the employee's mobile device is in Las Vegas, but another indicia of the employee's location is in Santa Cruz, then the system could conclude that the employee is not with the device and decline to issue or process any more security access requests until the situation is resolved, according to an embodiment of the invention. Such security should be helpful in preventing third parties from cloning such devices which should make third party security vendors more comfortable in sharing their applications. Additionally, the idea of wearable devices may provide extra power in such cases, as we know it's the employee who has the device because of the physical element, as this should reduce the possibility for imposters.

A facilities administrator, or IT administrator, has a tool by which to provision wearable access devices within his organization, using an approach such as Active Directory, with hand-shake credentials for various facilities or assets within their global facilities and properties, according to an embodiment of the invention.

Employing an AD-like function in the cloud services 302 means that access devices, such as the bracelet 308, can be validated in real-time, according to an embodiment of the invention. Among other things, this means that security certificates can be prepared to expire in short periods of time, which in combination with the biometrics reader 310 further improves security for the overall system, according to an embodiment of the invention.

In a non-work situation, the bracelet 308 could be used to get its owner into a gym, his home, a car, as well as the user's office—with the bracelet 308 managing different authentication certificates for each application, according to an embodiment of the invention.

The bracelet 308 provides contextual security information for the Security Identification System 300, according to an embodiment of the invention. In other words, one could assume that it would be more difficult to obtain the bracelet 308 than the keycard 104 or the mobile phone 204. One might have to enter a PIN into the bracelet, for example.

As additional security, the bracelet 308 could include a biometric reader 310 to further confirm that the holder of the bracelet 308 is the person intended to be its holder, according to an embodiment of the invention. The bracelet 308 provides an important security factor in a multi-factor authentication system such as the Security Identification System 300.

In short, the Security Identification System 300 can assume that if an employee puts on the bracelet 308 in the morning, and never takes off the bracelet 308, then the bracelet 308 is still worn by the employee. This cannot be as easily said of keycards, such as the keycard 104 shown in FIG. 1, or of mobile phones, such as the mobile phone 204 shown in FIG. 2, since such devices are not typically worn on the body in a manner as secure as the bracelet 308 and are subject to falling off or being put down and forgotten. The bracelet 308 represents one possible shape for a wearable identification device. Other shapes are possible, such as but not limited to rings, eyeglasses, according to various embodiments of the invention.

Key fobs, keycards, eyeglasses, rings, and other garments are also wearable access devices somewhat similar to the bracelet 308. One could typically assume that the bracelet 308 might be more secure than a key fob or a keycard because it should typically be more difficult to remove a bracelet, like the bracelet 308, then it would be to remove a key fob or a keycard. Similarly, a bracelet is somewhat less likely to be removed and forgotten or to simply fall off.

Assume that a user wears a wearable access device (e.g., the bracelet 308), and that it is confirmed that the device is being worn by its intended owner. Further, assume that the wearable access device has either direct cloud access (e.g., the cloud services 302) or indirect cloud access through a network host. Access to the cloud services 302 would be provided by a transceiver located in the bracelet 308, such as the transceiver package 404 shown in FIG. 4, according to an embodiment of the invention.

The bracelet 308 includes a security application 307, according to an embodiment of the invention. The security application 307 operates in roughly the same manner as the certificate app 206 shown in FIG. 2, according to an embodiment of the invention. The security application 307 is configured to communicate with the cloud services 302, according to an embodiment of the invention. As discussed above, the cloud services 302 may provide a more uniform and streamlined process for dealing with security access control certificates, especially proprietary security access control certificates. The cloud services 302 may also accommodate more elaborate and/or restrictive uses of security credentials from proprietary vendors and help make the system 300 more widely available and more widely deployed using proprietary security products from multiple vendors.

Returning to the Plantronics example, one can assume that if a Plantronics employee named Erik Perotti dons the bracelet 308 in the morning and uses it to enter the First Facility 108 at 9:00 a.m. and then leaves the facility at 10:30 a.m. that it is highly likely to be Mr. Perotti who presents the bracelet 308 at 12:30 p.m. when he appears at the Second Facility 110. Of course, it is possible for someone to steal the bracelet 308 from Mr. Perotti or for him to have misplaced it, but less likely than for him to lose the keycard or the mobile phone since they are not actually attached to his body.

The bracelet 308 may include a biometrics reader 310 to further increase the likelihood that the wearer of the bracelet 308 is the person to whom the bracelet 308 has been assigned. The biometrics reader 310 could comprise any sort of biometrics such as resting heart rate, body temperature, and/or something as simple as a PIN code, according to an embodiment of the invention. There are all kinds of biometric measurements that could be used, such as voice pattern and/or retina scan, for example. There are also things like patterns. If it's known that the user wakes up at 404 Nevada Street in Santa Cruz every day between 6:15 and 6:30 am, gets a bracelet wet for the duration of the user's shower, then drives straight from Nevada Street to the office, the security system can be fairly sure this is the user. When there is a variation, such as a stop at a coffee shop, for example, the certainty that it is the user is diminished (and thus security should be increased). So, if the user's heart rate in 10 bpm lower, and his bracelet has been to Nigeria and never goes to 404 Nevada St., then the security system could be configured to take a close look at the user when he presents himself at the First Facility 108.

Returning to the Plantronics example, the biometrics reader 310 could monitor Erik Perotti's heart rate, his body temperature, and/or another quality sufficiently unique to Mr. Perotti that the precise characteristic would be unique or nearly unique to him, e.g., a resting heart rate, average bodily temperature, or something selected by a user such as a PIN code, according to an embodiment of the invention.

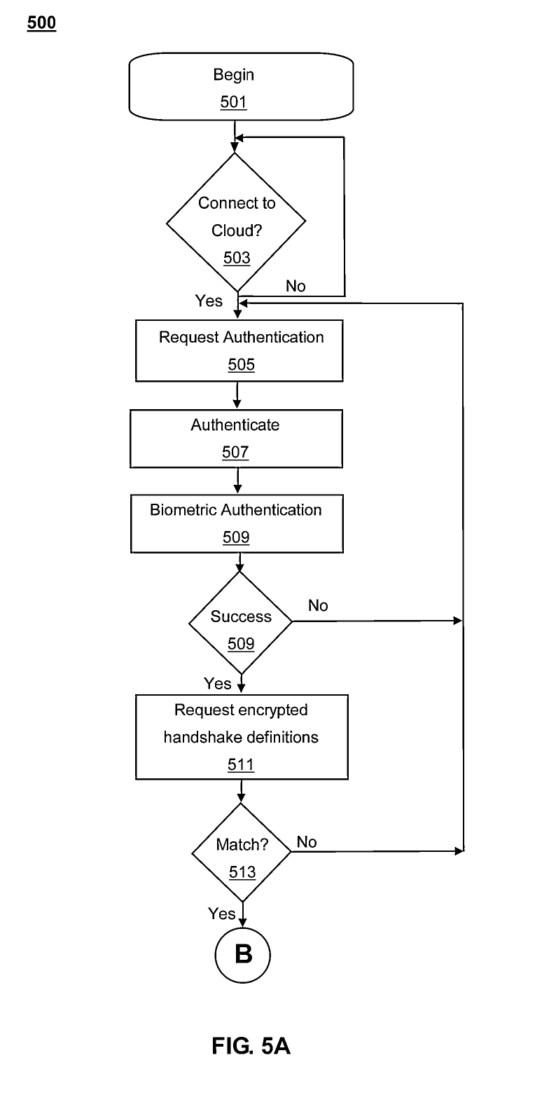

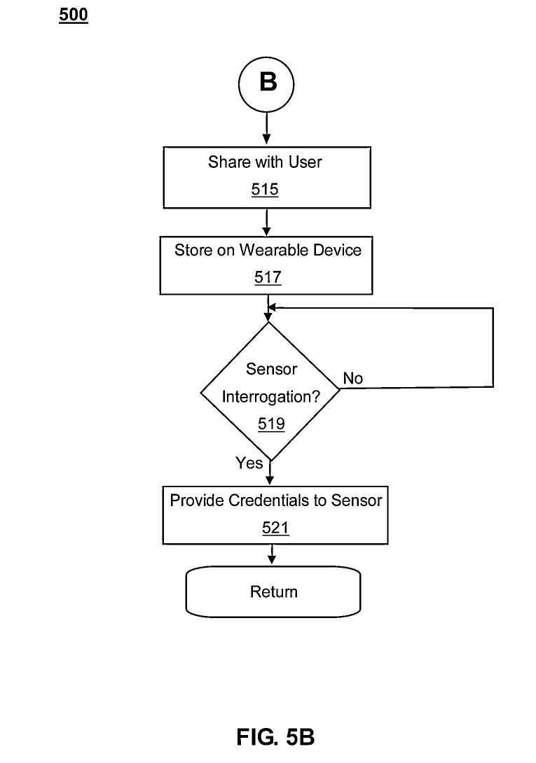

The bracelet 308 further includes the functionality discussed in FIG. 4, according to an embodiment of the invention. The bracelet 308 operates in a manner resembling the device described in FIG. 4 and FIGS. 5A-5B, according to an embodiment of the invention.

As mentioned in FIG. 2 in connection with the physical sensors 211, 213, the physical sensors 105, 109 may require physical modification in order for the system to work properly. For one thing, if the physical sensors 105, 109 have been configured to work with magnetic cards, they need to be configured to operate wirelessly or configured in whatever ways they need to be configured to receive a security access control certificate, such as the security access control certificates 311, 315.

FIG. 4 illustrates various components of a wearable access device 400, such as the bracelet 308 shown in FIG. 3, according to an embodiment of the invention. The wearable access device 400 comprises a certificate app 402, a biometrics reader 406, a transceiver package 404, a data repository 410, and a power supply 415, according to an embodiment of the invention. The certificate app 402 corresponds to the security application 307 shown in FIG. 3, and the biometrics reader 406 corresponds to the biometrics reader 310 shown in FIG. 3, according to an embodiment of the invention.

The certificate app 402 receives security credentials, or other security indicia, via the transceiver package 404 from a cloud services, such as the cloud services 302 shown in FIG. 3, according to an embodiment of the invention. The certificate app 402 provides similar functions to the certificate app 202 shown in FIG. 2, adapted as necessary to interface with cloud services, according to an embodiment of the invention.

The cloud services 302 might also leverage a companion device (such as a cell phone) to connect to the cloud. In some embodiments, the system 300 could include companion services for functionality such as a location service (GPS) and internet connectivity.

The certificate app 402 is configured to receive security credentials associated with external security systems, such as the security credentials generated by and/or sent by network authenticators, such as the Network Authenticators 303, 305 shown in FIG. 3, according to an embodiment of the invention. The certificate app 402 is configured to handle the transmission of security credentials both from network authenticators and sending security access certificates to sensor devices in a secure manner. The certificate app 402 may comprise separate functionality to handle proprietary security credentials, according to an embodiment of the invention.

In other words, an employee may need to visit multiple facilities where each facility uses a different security system provided by a different security vendor. If each of the security systems is proprietary, then the certificate app 402 and/or the cloud services (e.g., the cloud services 302 shown in FIG. 3) may need to handle the certificates in different manners. The certificate app 402 and/or the cloud services may comprise a configurable device that is adapted for handling new security certificate types and/or generating new forms of security access control certificates, according to an embodiment of the invention.

With reference to the Plantronics example, the certificate app 402 may be configured to provide security access control certificates for both the First Facility 108 (e.g., the company's Santa Cruz office) and the Second Facility 110 (e.g., the company's office in Swindon).

The biometrics reader 406 obtains biometric information associated with the user of the wearable access device 400 and compares the biometric information with previously collected and/or stored reference data for the intended user of the wearable access device 400, according to an embodiment of the invention.

When a user first puts on the wearable access device 400, the biometrics reader 406 either interrogates the user to provide the biometric information and/or the biometric reader 406 obtains the information automatically. In any event, by referencing the stored biometric information for the user against the currently detected biometric information, the biometric reader 406 can determine if the person wearing the wearable access device 400 is or is not the person intended to wear the wearable access device 400. The biometric reader can pass the “yes/no” or “ok/not-ok” report to other portions of the wearable access device 400, such as the certificate app 402, according to an embodiment of the invention.

At some point during the security approval process, the biometric reader 406 confirms that the appropriate person is the one wearing the wearable access device 400, according to an embodiment of the invention. On the other hand, if the user presently wearing the wearable access device 400 fails the test and cannot confirm that he/she is the intended wearer of the wearable access device 400, then the biometric reader 406 will also pass this information to appropriate portions of the security approval process, and security clearance will be denied.

The biometric reader 406 may also be configured to send a message via the transceiver package 404 to a cloud services, such as the cloud services 302 shown in FIG. 3, indicating that the wearable access device 400 has been compromised and is not presently being worn by the intended party, according to an embodiment of the invention.

The biometrics reader 406 can be a conventional device of its type and does not necessarily need to be customized for the wearable access device 400, according to an embodiment of the invention.

With reference to the Plantronics example, the biometric reader 406 could be configured to hold reference biometric information for Plantronics employee Erik Perotti, such as his resting heart rate, body temperature, and/or something as simple as a PIN code. Assume that at some point, Erik Perotti has trained the biometric reader 406 to know one or more biological measurements that are unique (or nearly unique) to him, according to an embodiment of the invention.

A PIN Code could be used in any of the form factors, according to an embodiment of the invention. The PIN code could be used either to augment or in place of biometric information. In some embodiments, something other than a PIN code might be used and instead an aspect of security could be a user interaction, like a gesture or drawing a secret image (e.g., the user writes a signature or something), and the biometric reader 406 has the ability to compare the user's gesture with a reference gesture stored in the data repository 410, according to an embodiment of the invention.

The transceiver package 404 is configured to communicate with external devices, such as the cloud services 302 shown in FIG. 3 and with external sensors associated with a given facility, such as the sensors 211, 213 shown in FIG. 2, according to an embodiment of the invention. The transceiver package 404 can be set to operate over any conventional communications protocol.

In some embodiments of the invention, the transceiver package 404 may comprise essentially a set of different transceiver types, such as a transceiver designed for communicating with the cloud services, such as the cloud services 302 shown in FIG. 3, and another transceiver designed to communicate with the external sensors of the security system, such as the sensors 209, 211 in FIG. 2. The cloud services 302, for example, might be reachable in some configurations via a connection over wireless telephony lines, a mesh network, or via a protocol such as Wi-Fi while the security sensors might be reachable via another communications protocol, possibly even a proprietary one or something like SSL. In some embodiments, the transceiver package 404 might even include one transceiver designed for communication with one type of external sensor (e.g., the sensor 213 shown in FIG. 2) and a second transceiver designed for communication with a second type of external sensor (e.g., the sensor 211 shown in FIG. 2).

The power supply 415 provides electrical power to the components of the wearable access device 400, according to an embodiment of the invention. The power supply 415 could comprise a battery or batteries, although other sources of power are possible. The power supply 410 may have dual function. For example, the power supply 410 associated with a mobile phone, such as the mobile phone 204 shown in FIG. 2.

The data repository 410 comprises a secure database for holding security access control certificates processed by the certificate app 402, according to an embodiment of the invention. The data repository 410 working with the certificate app 404 ensures that the security access control certificates are processed in a secure manner. As shown in FIG. 4, the data repository 410 holds a first security access control certificate 420 and a second security access control certificate 422. Of course, the data repository 410 could hold more or fewer security access control certificates, depending on the security clearances associated with the user of the wearable access device 400. The data repository 410 may perform storage functions for data not associated with the security access control certificates, according to an embodiment of the invention.

FIGS. 5A-5B provide a flowchart 500 that illustrates operations of a security identification system for a wearable access device, such as the security identification system 300 shown in FIG. 3, according to an embodiment of the invention.

The wearable access device (e.g., the bracelet 308) connects 503 to the cloud services 302 shown in FIG. 3. If the wearable access device connects to the cloud, then the device requests 505 authentication, according to an embodiment of the invention. If the wearable access device cannot connect to the cloud services, then the wearable access device repeats its attempt to reach the cloud services, possibly after waiting for a time interval, according to an embodiment of the invention. In an alternative embodiment, if the device cannot reach the Internet but the wearer is expected to come into the office, and the device was worn at the right time, then the device might not need to request a certificate.

A service in the cloud 302 authenticates 507 a user associated with the wearable access device (e.g., the bracelet 308) through a technology such as Active Directory as discussed at FIG. 3, according to an embodiment of the invention.

The user may also be authenticated 509 by a biometrics measurement, such as one taken by the biometrics reader 310 shown in FIG. 3, and/or a security code (e.g., a PIN code), according to an embodiment of the invention.

If the authentication steps are successful 509, the wearable access device (e.g., the bracelet 308) then requests 511 any encrypted hand-shake definitions available to it through an encrypted channel associated with the cloud services 302, according to an embodiment of the invention. The set of handshake definitions and/or security credentials would originate from one of more network authenticators (e.g., the Network Authenticators 303, 305) and provide the user's set of security certificates, according to an embodiment of the invention. If the authentication is not successful, the wearable access device tries again to complete authentication, possibly after waiting a period of time, according to an embodiment of the invention.

If there are any definitions in the cloud services 302 that match 513 the profile of the user associated with the bracelet 308 in Active Directory, then the cloud services share 515 the handshake definitions and/or security certificates with the user's device (e.g., the bracelet 308). If the process is not successful, then the cloud services and/or the wearable access device tries again to receive the handshake definitions and/or security certificates, possibly after waiting a period of time, according to an embodiment of the invention.

The wearable access device stores 517 any received handshake definitions and/or security certificates in a data repository on the wearable device, such as the data repository 410 shown in FIG. 4, according to an embodiment of the invention. The user of the wearable access device (e.g., the bracelet 308) has then received one or more physical access definitions for the associated wearable access device, and is authenticated for facility access for at least one facility (e.g., the First Facility 108 shown in FIG. 3).

When the user of the wearable access device (e.g., the bracelet 308) approaches an entrance or facility that requires authentication (e.g., the First Facility 108, the Second Facility 110), and is interrogated 519 by sensors (e.g. the sensors 109, 111 shown in FIG. 1) associated with the facility, the wearable access device provides 521 the proper handshake detail over the appropriate facilities protocol to the facility's sensor (e.g., the sensor 105, 109) by providing the security access control certificates 521 which motivates the opening of the appropriate set of physical locks. In some instances, a certificate app (e.g., the certificate app 402 shown in FIG. 4) may need to modify the security access control certificates provided to a physical sensor in order to comply with a proprietary format and/or a physical device that has different physical characteristics.

FIGS. 5A-5B have illustrated but one example for how such a system would connect to the cloud, validate the user, and dispense security access control certificates. An ordinary artisan could easily see this same approach being applied to multiple authentication systems. For example, an ordinary artisan could consider Facebook, Twitter, Foursquare or other similar utility serving a similar function as the cloud services 302, according to an alternative embodiment of the invention.

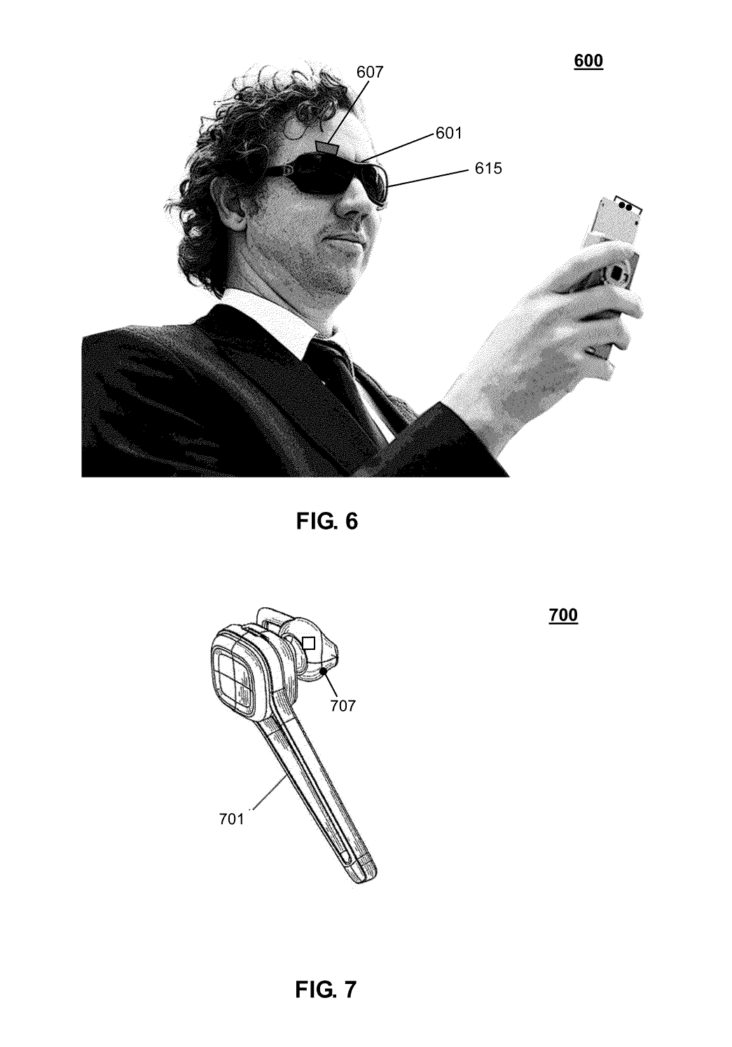

FIG. 6 illustrates a security identification system 600 in which the wearable access device comprises a pair of eyeglasses 601, according to an embodiment of the invention. The components 607 of the security identification system 600 can be emplaced inside the eyeglasses 601 and/or provided as an add-on package that attaches to the eyeglasses 601, according to an embodiment of the invention.

The security identification system 600 comprise a certificate app, a biometrics reader, a transceiver package, a data repository, a small computing device, and a power supply, according to an embodiment of the invention. These components collectively function in a manner resembling the wearable access devices shown in FIG. 4 and FIGS. 5A-5B, according to an embodiment of the invention.

Lenses 615 for the eyeglasses 601 need not necessarily provide a corrective function. The eyeglasses 601 could possibly comprise a pair of sunglasses, according to an embodiment of the invention. The eyeglasses 601 could be fitted with lenses 615 that respond to changes in sunlight such that when the user enters a building, e.g., the First Facility 108 that the lenses immediately lighten.

As an alternative embodiment, the eyeglasses 601 could be designed such that the user no longer needs to wear them once inside the First Facility 108. For example, if the facility contained a series of secure doors, each having a sensor, such as the sensor 109 shown in FIG. 1, then the user could simply don the eyeglasses 601 in proximity to the sensor, according to an embodiment of the invention.

FIG. 7 illustrates a security identification system 700 where the wearable access device comprises an audio device, such as an ear bud 701, according to an embodiment of the invention. The security identification system 700 comprises a certificate app, a biometrics reader, a transceiver, a data repository, a small computing device and a power supply. The ear bud 701 operates as an audio device that includes the functionality described in FIGS. 4-5, according to an embodiment of the invention.

The ear bud 701 includes functionality for audio communications, such as service as a Bluetooth device, according to an embodiment of the invention. In some embodiments, the transceiver package in the ear bud 701 could be configured to communicate the non-security audio information normally and conventionally transmitted by the ear bud 701. The ear bud 701 otherwise operates in a conventional manner.

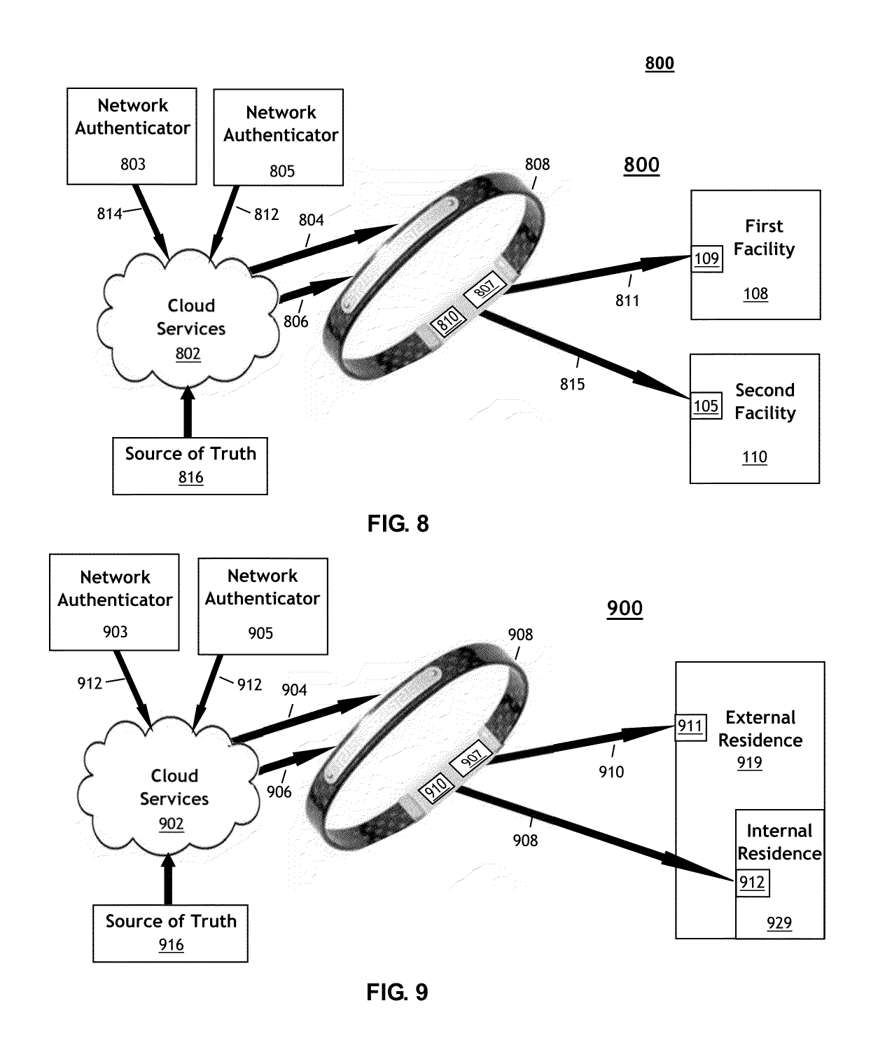

FIG. 8 illustrates a security identification system 800 where the wearable access device comprises a ring 808, according to an embodiment of the invention. The ring 808 comprises a certificate app 810 and a biometrics reader 807. The ring 808 also includes a transceiver, a data repository, a small computing element, and a power supply. The ring 808 includes the functionality described in FIGS. 4-5, according to an embodiment of the invention. The ring 808 otherwise operates in a conventional manner.

FIG. 9 illustrates a residential security identification system 900 that operates along similar principles to the Security Identification System 300 shown in FIG. 3, according to an embodiment of the invention.

The Security Identification System 900 may comprise a series of sensors 911, 912 in the residence having different secure doors wherein different occupants may different permissions, according to an embodiment of the invention. For example, a residential compound might comprise an external residence 919 and an internal residence 929. Not all persons having access to the external residence 919 would necessarily have access to the internal residence 929. The internal residence could be a room, a suite, a safe, or even something as small as a liquor cabinet, according to an embodiment of the invention.

The user here can unlock his residential front door (e.g., the external residence 919) once it is known to the physical locking system that he has been authenticated through a cloud service (or a similar service provided through a social network such as Facebook), if the user's wearable also happens to be authenticated against Active Directory, according to an embodiment of the invention.

The computerized Source of Truth 916 could operate using one of the authentication systems previously described (e.g., ActiveDirectory). Alternatively, the computerized Source of Truth 916 a popular authentication engine, such authentication engines linked to popular social network sites, such as Facebook, LinkedIn, and Twitter, according to an embodiment of the invention.

In the security identification system 900, each authenticated user might have access to rooms, systems, sub-compartments that are not accessible to other users possessing access to the outdoor. So, for example, only mom and dad might have access to the lock on the liquor cabinet and/or the door to the master bedroom, and close friends on Facebook might be able to access the front door.

Embodiments of the invention are also applicable to applications beyond just opening physical locks. The security access control certificates, or certificates prepared in a similar manner, could be applied to areas beyond just opening physical locks. For example, the Security Identification System could be used to enable other non-security functionality. For example, the Security Identification System could be used provide a “Follow You Printing” system in which a user with a security badge (e.g., the mobile phone 204, the bracelet 308, or the ring 808) approaches a printer (e.g., a networked printer), swipes his security badge, and the printer outputs whatever the employee has queued for printing system. There are additional ways in which an ordinary artisan could leverage the Security Identification Systems described herein for other uses that did not necessary involve security applications.

While specific embodiments of the invention have been illustrated and described, it will be clear that the invention is not limited to these embodiments only. Embodiments of the invention discussed herein have generally been described using Plantronics equipment (e.g., ear buds); however, the invention may be adapted for use with equipment from other sources and manufacturers. Equipment used in conjunction with the invention may be configured to operate according to a conventional computer protocol (e.g., USB) and/or may be configured to operate according to a specialized protocol (e.g., a Plantronics serial bus). Numerous modifications, changes, variations, substitutions and equivalents will be apparent to those skilled in the art without departing from the spirit and scope of the invention as described in the claims. In general, in the following claims, the terms used should not be construed to limit the invention to the specific embodiments disclosed in the specification, but should be construed to include all systems and methods that operate under the claims set forth hereinbelow. Thus, it is intended that the invention covers the modifications and variations of this invention provided they come within the scope of the appended claims and their equivalents.

We claim:

1. A security identification system that operates in conjunction with a plurality of network authenticators, comprising:
a computerized certificate application configured to receive a plurality of security credentials from the plurality of network authenticators, wherein each received security credential comprises an access code to a locked physical facility, and wherein each received security credential has been differently coded in comparison to at least one other security credential received by the certificate application, wherein the computerized certificate application processes different types of security credentials prepared by different types of network authenticators and prepares security access certificates from the received security credentials; and
a transceiver package configured to receive a plurality of security credentials from the plurality of network authenticators and further configured to transmit security access control certificates prepared by the computerized certificate application to at least one sensor associated with a locked physical facility wherein transmitted security access control certificates engage unlocking the locked physical facility for a user associated with the computerized certificate application; and
a data repository configured to store security access control certificates prepared by the computerized certificate application.

2. The security identification system of claim 1, further comprising:
a biometrics reading device configured to receive an identifying characteristic from the user of the computerized certificate application and compare the identifying characteristic sample with a reference standard from an authorized user of the security identification system, wherein the biometrics reading device generates an access signal if the identifying characteristic sample matches the reference standard.

3. The security identification system of claim 2 wherein the biometrics reading device is configured to operate on identifying characteristic samples comprising at least one of resting heart rate, body temperature, voice pattern retinal scan and/or a personal identification number.

4. The security identification system of claim 1, further comprising:
a cloud services facility configured to communicate with a plurality of network authenticators and the computerized certificate application, wherein the cloud services facility processes handshake data from the computerized certificate application to prepare security credentials provided by at least one network authenticator of the plurality of network authenticators and then sends the prepared security credentials to the computerized certificate application.

5. The security identification system of claim 4 wherein the computerized certificate application requests security credentials from the cloud services facility after the computerized certificate application has received a credential query from a sensor associated with a locked physical facility.

6. The security identification system of claim 1 wherein the computerized certificate application resides in a wearable access device.

7. The security identification system of claim 6 wherein the wearable access device comprises a bracelet.

8. The security identification system of claim 6 wherein the wearable access device comprises a pair of eyeglasses.

9. The security identification system of claim 6 wherein the wearable access device comprises an ear bud.

10. The security identification system of claim 6 wherein the wearable access device comprises a ring.

11. The security identification system of claim 1 wherein the computerized certificate application has been included in a mobile phone and wherein access to the computerized certificate application requires entry of a PIN code.

12. The security identification system of claim 1, further comprising:
a power source that provides electrical power to at least the components of the security identification system.

13. A method for providing a security identification system that operates in conjunction with a plurality of network authenticators, comprising:
receiving a plurality of security credentials on a computerized certificate application from the plurality of network authenticators, wherein each security credential comprises an access code to a locked physical facility, and wherein each security credential has been uniquely coded in comparison to at least one other security credential received by the computerized certificate application, and wherein the computerized certificate application processes different types of security credentials prepared by different types of network authenticators and prepares security access certificates from the received security credentials;
receiving a plurality of security credentials from the plurality of network authenticators by a transceiver package and transmitting security access control certificates prepared by the computerized certificate application to at least one sensor associated with a locked physical facility wherein transmitted security access control certificates engage unlocking the locked physical facility for a user associated with the computerized certificate application; and
storing security access control certificates prepared by the computerized certificate application in a data repository.

14. The method of claim 13, further comprising:
receiving in a biometrics reading device an identifying characteristic from the user of the computerized certificate application, comparing the identifying characteristic sample with a reference standard from an authorized user of the security identification system and generating an access signal if the identifying characteristic sample matches the reference standard.

15. The method of claim 14 wherein the biometrics reading device is configured to operate on identifying characteristic samples comprising at least one of resting heart rate, body temperature, voice patter, retinal scan, and/or a personal identification number.

16. The security identification system of claim 13, further comprising:
processing handshake data from the computerized certificate application by a cloud service facility to prepare security credentials provided by at least one network authenticator of the plurality of the network authenticators and sending the security credentials to the computerized certificate application wherein the cloud services facility communicates with network authenticators and the computerized certificate application.

17. The security identification system of claim 16, further comprising:
requesting security credentials by the computerized certificate application from the cloud services facility after the computerized certificate application has received a credential query from a sensor associated with a locked physical facility.

18. The security identification system of claim 13 wherein the computerized certificate application resides in a wearable access device.

19. The security identification system of claim 18 wherein the wearable access device comprises a bracelet.

20. The security identification system of claim 18 wherein the wearable access device comprises a pair of eyeglasses.

21. The security identification system of claim 18 wherein the wearable access device comprises an ear bud.

22. The security identification system of claim 18 wherein the wearable access device comprises a ring.

23. The security identification system of claim 13 wherein the certificate application has been included in a mobile phone and wherein access to the computerized certificate application requires entry of a PIN code.
